(19) United States
(12) Patent Application Publication
(10) Pub. No.: US 2003/0081852 A1
(43) Pub. Date: May 1, 2003

(54) Encoding method and arrangement

(76) Inventor: Teemu Pohjola, Helsinki (FI)

Correspondence Address: SALTAMAR INNOVATIONS, 30 FERN LANE, SOUTH PORTLAND, ME, 04106, US

(21) Appl. No.: 10/001,861

(22) Filed: Nov. 19, 2001

(30) Foreign Application Priority Data
Oct. 30, 2001 (FI) 20012095

(51) Int. Cl. G06K 9/46

(52) U.S. Cl. 382/253; 382/250

(57) ABSTRACT

This invention relates to encoding and decoding images. The invention is a variant of the cascaded VQ with certain improvements acquired from the DCT and DWT approaches. The fundamental aspects of the invention are that codebooks are pre-processed when training them for predetermining the frequency distribution of the resulting codevectors, and each block is independently coded and decoded using a variable number of stages of difference coding needed for coding the particular block.

### FIELD OF THE INVENTION

This invention relates to encoding and decoding images. More specifically, the invention relates to encoding and decoding video in streaming media solutions. Streaming media means that a video is transmitted through a network from a sending party to a receiving party in real-time when the video is shown on the terminal of the receiving party.

### BACKGROUND OF THE INVENTION

A digital video consists of a sequence of frames—there are typically 25 frames per second—each frame consisting of M1×N1 pixels, see FIG. 1. Each pixel is further represented by 24 bits in some of the standard color representations, such as RGB where the colors are divided into red (R), green (G), and blue (B) components that are further expressed by a number ranging between 0 and 255. A capacity of a stream of M1×N1×24×25 bits per second (bps) is needed for transmitting all this information. Even a small frame size of 160×120 pixels yields 11,5 Mbps and is beyond the bandwidth of most fixed and, in particular, all wireless Internet connections (9.6 kbps (GSM) to some hundreds of kbps within the reach of WLAN). However, all video sequences contain some amount of redundancy and may therefore be compressed.

Any video signal may be compressed by dropping some of the frames, i.e., reducing the frame rate, and/or reducing the frame size. In color videos, a clever choice of the color representation may further reduce the visually relevant information to one half bit count or below, for example the standard transition from RGB to YCrCb representation. YCrCb is an alternative 24 bit color representation obtained from RGB by a linear transformation. The Y component takes values between 0 and 255 corresponding to the brightness or the grayscale value of the color. The Cr and Cb components take values between −128 and +127 and define the chrominance or color plane. In radial coordinates, the angle around the origin or hue determines the actual color while the distance from the origin corresponds to the saturation of the color. In what follows, these origin corresponds to the saturation of the color. In what follows, these kinds of steps are assumed taken and the emphasis is on optimal encoding of the detailed information present in the remaining frames.

All video compression techniques utilize the existing correlations between and within the frames, on the one hand, and the understanding of the limitations of the human visual system, on the other. The correlations such as immovable objects and areas with constant coloring, may be compressed without loss, while the omission of invisible details is by definition lossy. Further compression requires compromises to be made in the accuracy of the details and colors in the reproduced images.

In absence of cuts (a change of scene) in a video, the consecutive frames differ only if the camera and/or some of the objects in the scene have moved. Such a series of frames can be efficiently encoded finding the directions and magnitudes of these movements and conveying the resulting motion information to the receiving end. This kind of procedure is called motion compensation; the general idea of referring to the previous frame is known as INTER (frame) encoding. Thus an INTER frame closely resembles the previous frame(s). Such a frame can be reconstructed with the knowledge of the previous frame and some amount of extra information representing the changes needed. To get an idea of the achievable compression ratios, let us consider an 8×8 pixel block 2 (see FIGS. 2 and 3), which corresponds to 8×8×24=1536 bits in the original form. If the movement of the block between two consecutive frames 1 is limited between, e.g., −7 and 7 pixels, the two-dimensional motion vector can be expressed with 8 bits resulting in a compression ratio of 192.

In order for this method to work, the first frame after each cut needs to be compressed as such—this is called INTRA encoding. Thus an INTRA frame is a video frame that is compressed as a separate image with no references made to any other frame. INTRA frames are needed at the beginning of a video stream, at cuts, and to periodically refresh the video in order to recover from errors.

Retaining good visual quality of the compressed videos is just one of the many requirements facing any practical video compression technology. For commercial purposes, the encoding process should be reasonably fast in order to facilitate the encoding of large amounts of video content. Apart from a possible initial buffering of frames in the computer's memory, the viewing of a video typically occurs in real time demanding real time decoding and playback of the video. The range of intended platforms from PC's (personal computers) to PDA's (personal digital assistant) and possibly even to third generation mobile phones sets further constraints on the memory usage and processing power needs for the codecs (coder-decoder).

Fast decoding is even more important for the so-called streaming videos, which are transmitted to the receiver in real time as the user watches. For streaming videos, a limited data transmission capacity imposes a minimum compression ratio over the full length of the video. This is because the bit rate for transmitting the video must remain within the available bandwidth at all times.

Most video compression technologies comprise two components: an encoder used in compressing the videos and a decoder or player to be installed in the prospective viewing apparatus. Commonly, such decoders are downloaded into the viewing apparatus for being installed permanently or just for the viewing time of a video. Although this downloading needs to be done only once for each player version, there is a growing interest towards player-free streaming video solutions, which can reach all internet users. In such solutions, a small player application is transmitted to the receiving end together with the video stream. In order to minimize the waiting time due to this overhead information, the application, i.e., the decoder, should be made extremely simple.

For present purposes in this text it is sufficient to consider gray-scale frames/images (color images and different color representations are straight-forward generalizations of what follows). The gray-scale values of the pixels are denoted as the luminance Y. These form a two-dimensional array in a frame and the challenge to the encoding process is to perform the compression and decompression of this array in a way that retains as much of the visually relevant information in the image as possible.

In the INTRA mode, (video or image compression technique used in encoding INTRA frames) each frame is just a gray-scale bitmap image. In practice the image is typically divided into blocks of N×N pixels 2 and each block is analysed independent of the others, see FIG. 3.

The simplest way to compress the information for an image block is to reduce the accuracy in which the luminance values are expressed. Instead of the original 256 possible luminance values one could consider 128 (the values 0,2, . . . ,254) or 64 values (0,4, . . . ,252) thereby reducing the number of bits per pixel needed to express the luminance information by 12.5% and 25%, respectively. Simultaneously such a scalar quantization procedure induces encoding errors; in the previous exemplary cases the average errors are 0.5 and 1 luminance unit per pixel, respectively. The scalar quantization is very inefficient, however, since it neglects all the correlations between neighbouring pixels and blocks that are present in any real image.

One way to account for the correlations between the pixels is to conceive the image, i.e., the luminance values of the pixels, as a two dimensional surface. Many of the existing image compression algorithms are based on functional transforms in which the functional form of this surface is decomposed in terms of some set of basis functions.

The most widely used transforms are the discrete cosine transform (DCT) and the discrete wavelet transform (DWT), where the basis is formed by cosines and wavelets, respectively. The larger block sizes account for correlations between the pixels over longer distances; the number of basis functions increases as N² at the same time. In the JPEG and MPEG standards, for example, the block size for the DCT coding is 8×8. The key difference between DCT and DWT is that, in the former, the basis functions are spread across the whole block while, in the latter, the basis functions are also localized spatially.

In the INTER mode, (An INTER mode is a video compression technique used in compressing INTER frames or blocks therein. INTER modes refer to the previous frame(s) and possibly modify them. Motion compensation techniques are representative INTER modes.) the motion compensated blocks may not quite match the originals. In many cases, the resulting error is noticeable but still so small that it is easier to convey the correction information to the receiving end rather than to encode the whole block anew. This is because the errors are typically small and they can be expressed with a lower number of bits than the luminance values in an actual image block. Apart from this distinction, the difference blocks can be encoded in a similar fashion as the image blocks themselves.

As an alternative to the functional transforms one can employ vector quantization (VQ). In VQ methods, the N×N image blocks 2, or N² vectors 3 (see FIG. 3), are matched to vectors of the same size from a pre-trained (trained prior to the actual use) codebook (a collection of codevectors). For each block, the best matching code vector is chosen to represent the original image block. All the image blocks 2 are thus represented by a finite number of code vectors 4, i.e., the vectors are quantized. The indices of the best matching vectors are sent to the decoder and the image is recovered by finding the vectors from the decoder's copy of the same codebook.

The encoding quality of VQ depends on the set of training images used in preparing the codebook and the number of vectors in the codebook. The dimension of the vector space depends quadratically on the block dimension N (N² pixel values) whereas the number of possible vectors grows as 256^{N}^{²}—the vectors in the codebook should be representative for all these vectors. Therefore in order to maintain a constant quality of the encoded images while increasing the block size, the required codebook size increases exponentially. This fact leads to huge memory requirements and quite as importantly to excessively long search times for each vector. Several extensions of the basic VQ scheme have been proposed in order to attain good quality with smaller memory and/or search time requirements.

Some extensions such as the tree-search VQ only aim at shorter search times as compared to the codebook size. These algorithms do not improve the image quality (but rather deteriorate it) and are of interest here only due to their potential for speeding up other VQ based algorithms.

The VQ algorithms aiming at improving the image quality typically use more than one specialized codebook. Depending on the details of the algorithm, these can be divided into two categories: they either improve the encoded image block iteratively, see FIG. 4, such that the encoding error of one stage is further encoded using another codebook thereby reducing the remaining error, or they first classify the image material in each block and then use different codebooks (411, 412, 413) for different kinds of material (edges, textures, smooth surfaces). The multi-stage variants are often denoted as cascaded or hierarchical VQ, while the latter ones are known as classified VQ. The motivation behind all these is that by specializing the codebooks, one reduces the effective dimension of the vector space. Instead of representing all imaginable image blocks, one codebook can dedicated, for example, to the error vectors whose elements are restricted below a given value (cascaded) or blocks with an edge running through them (classified). In cascaded VQ variants, the vector dimension is often further reduced by decreasing the block size between the stages.

The key advantages in transform coding technologies are their analytically predictable properties and the resulting decorrelated coefficients ranked in terms of their relative importance. These aspects enable efficient rate-distortion control and scalability of a stream according to an available transmission line bandwidth.

Transforms such as DCT, where all the basis functions extend over the same block area, are more prone to blocking artefacts than DWT like approaches, where the spatial location and extension of the basis function varies. This difference is evident, e.g., when encoding image blocks containing sharp edges (sharp transitions between dark and bright regions). The DCT of such a block yields, in principle, all possible frequencies in at least one spatial direction. In contrast to this, the DWT of the block may lead to just a few nonzero coefficients. The DCT, on the other hand, is more efficient for encoding larger smoothly varying surfaces or textures, which in turn would require large numbers of nonzero wavelet coefficients.

In most actual image blocks, the number of zero transform coefficients is larger than that of the nonzero ones. Hence the encoding efficiency of the transform techniques is to a large extent determined by the efficiency of expressing the zeros without using and transmitting several bits for each and every one of them. In DCT, the coefficients are ranked from the most important and frequently occurring to the least important and rarest. The zeros often occur in sequences and are thus efficiently run-length codable. In DWT, the coefficients are ranked into spatially distinct hierarchies, where the zero coefficients often occur at once in whole branches of the hierarchy. Such branches can then be collectively nullified by one code word.

All the transform coding technologies share one major drawback, namely their computationally heavy decoding side. The decoding involves inverse functional transformations and requires a PC class or better processors, or specialized hardware decoders, to provide sufficient decoding speed. These requirements leave out PDA devices and mobile phones. Typically transform coding is also tied to specific player solutions that need to be downloaded and installed before any video can be viewed.

Another disadvantage of the transform codecs occurs in the context of difference encoding. The difference between the original and the encoded frames and individual blocks depends on the methods used in the initial encoding of the image. For transform coding methods, the remaining difference is only due to quantization errors induced but, for motion compensation schemes or VQ type techniques, the difference is often relatively random although of small magnitude. In this case, the functional transformations yield arbitrary combinations of nonzero components that may be even more difficult to compress than the coefficients of the actual image.

The advantages and disadvantages of vector quantization techniques are quite the opposite from those produced by transform codecs. The compression techniques of VQ codecs are always asymmetric with the emphasis on an extremely light decoding process. In its simplest form, the decoding merely consists of table lookups for the code vectors. The player application can be made very small in size and sent at the beginning of the video stream.

A code vector corresponds to a whole N×N block or alternatively to all the transform coefficients for such a block. If one vector index is sent for each block, the compression ratio is bigger the larger the block size is. However, a big codebook is needed in order to obtain good quality for large N. This implies longer times for both the encoding—vector search—and the transmission of the codebook to the receiving end.

On the other hand, the smaller the blocks, the more accurate the encoding result becomes. Smaller blocks or vectors also require smaller codebooks, which require less memory and are faster to send to the receiving end. Also the code vector search operation is faster rendering the whole encoding procedure faster. The disadvantage of smaller block size is the larger amount of indices to be transmitted.

In the improved VQ variants, vector space is split into parts and one codebook is prepared for each part. In the cascaded VQ, in particular, the image quality is improved by an effective increase in the number of achievable vectors V achieved with the successive stages of encoding. In the ideal case, where the vectors in the different stages were orthogonal, adding a stage i with a codebook of Vᵢ vectors would increase V to V×Vᵢ. This procedure can significantly improve the image quality with reasonable total codebook size and search times. This improvement is done at the expense of the number of bits needed to encode each block; this increases by n if Vᵢ=2ⁿ. The image quality is further improved if the block size is reduced between stages.

There are two problems with the cascaded VQ, however. Firstly, the codebooks are typically trained on realistic difference blocks but with no reference to the human visual system. Consequently, the vectors do not necessarily make the corrections, which are visually the most pleasing. Secondly, the number of bits needed to encode each block grows with the number of stages used and even more rapidly if the block size is reduced on the way since a number of indices increases. In other words reduction of block size causes even more pronounced rise in the number of bits required for transmitting the video.

The intention of the invention is to alleviate the above-mentioned drawbacks.

### SUMMARY OF THE INVENTION

Unless otherwise is implied by the context, the following definitions should be taken into account when reading these specifications.

Basic mode. Image or video compression technique designed to encode an image or a video frame. The term is used as a distinction from difference modes.

Coding. Generally denotes compression, and/or encoding. Since compression is a basic action when coding in this context, the coding can be understood as acts for making the compression. Thus the terms ‘coding’, ‘encoding’, or ‘compression’, stand generally for any act of transforming an image or video data to render it better suitable for transmission.

Decoding. indicates generally the reversal of the coding process, i.e. transforming the encoded data back to a representation of the information content prior to encoding. Such decoding may or may not be ‘lossy’, or ‘noisy’, i.e. the decoded information content may be less than the original information content, or have additional ‘noise’ artefacts.

Difference mode. Image or video compression technique used to encode the difference between two frames, usually between the original and encoded frames. In the latter case, the difference is denoted as the encoding error.

Distortion. Measure of the encoding error. Typically Euclidian norm of the pixel-wise differences in the original and encoded luminance values.

The solution according to the invention combines the best properties of several of the existing solutions. In short, it is a variant of the cascaded VQ with certain improvements acquired from the DCT and DWT approaches. The fundamental aspects of the invention are that codebooks are pre-processed when training them for predetermining the frequency distribution of the resulting codevectors, and each block is independently coded and decoded using a number of stages of difference coding needed for coding the particular block. When training codebooks, the codebooks are taught using special training images to correspond to certain image features. The invention takes a difference block as input and encodes it further in order to reduce the remaining error in an efficient manner as compared with the additional bits required. The difference block may be the result from any conceivable basic encoding including basic VQ encoding, motion compensation, DCT, and DWT. The invention significantly improves the image quality in proportion to the bit rate (bps) used, regardless of both the INTER and the INTRA encoded frames.

In accordance with the above-mentioned matters the invention concerns an encoding method for compressing data, in which method the data is first encoded and difference data between the original data and the encoded data is formed, the difference data is divided into one or more primary blocks, which are encoded at least at one stage, each encoding stage comprising the action of the encoding and, if needed for the next encoding stage, an action of calculating a following difference blocks between the current difference blocks and the encoded current difference blocks, performing the consecutive stages in a way that the calculated difference blocks at the previous stage are an input for the following stage, at each stage using a codebook, which is specific for the encoding of the stage, until at a final stage, final difference blocks between the previous difference blocks and the encoded previous difference blocks are encoded using the last codebook, the codebooks for said difference blocks containing codevectors trained with training difference material, and in that prior the training, the training difference material is preprocessed for individually adapting frequency distribution of each codevector for weighting to particular information of the data, and encoding each block independently using a necessary number of the stages needed for the particular block.

Yet the invention concerns an encoder, which utilizes the inventive encoding method in a way that at least one codebook used for coding differences has been weighted to a specific frequency distribution, and the encoder comprises evaluation means for assigning a necessary number of the stages needed for the particular block.

Furthermore taking into account the inventive encoding, the invention concerns a decoding method for decompressing data, the method comprising codebooks for the decompression of encoded difference data, wherein at least one of said codebooks contains codevectors, which have been weighted to a specific frequency distribution, and using the codebooks together performing a decompression result, which comprises at least the most significant frequencies.

And furthermore, the invention concerns a decoder using codebooks for the decompression of encoded difference data, wherein at least one of the codebooks has been weighted to a specific frequency distribution.

Thus it is an aspect of the present invention to provide an encoding method for compressing data, the method comprising the steps of encoding the data to produce encoded data and forming difference data between the data and the encoded data. The next steps comprises dividing the difference data into one or more primary blocks, forming difference blocks, and using a selected codebook re-encoding a difference block to produce an encoded difference block; calculating a following difference block between said difference block and the encoded difference block, forming secondary difference blocks. These steps are iteratively repeated for a plurality of selected primary and secondary difference blocks until a desired level of compression is achieved. The codebook for re-encoding is selected for each iteration from a plurality of codebooks. At least one of the codebooks contains codevectors trained with training difference material, wherein prior to the training, said training difference material is preprocessed for individually adapting frequency distribution of at least one of said codevectors for weighting to particular portions of the data. A plurality of codebooks may be used in combination. Preprocessing may be carried out usig a discrete cosine transform, or any other functional transform.

In a preferred embodiment, in at least at one of said repetitions the difference blocks are divided into sub-blocks at least one of which to be used as difference blocks at a subsequent repetition.

Preferably the method further comprises evaluating the cost of a repetition using a cost function which produces a cost result, and deciding if to perform the next repetition based on the basis of said result. More preferably, the cost function utilizes a remaining difference, and a number of bits used for representing said difference block, to calculate a cost of further repetitions. Most preferably, the number of bits is weighted.

Optionally, in at least at one repetition the difference blocks are preprocessed before encoding.

It is yet another aspect of the invention to provide a decoding method for pre-compressed data, the method comprising the steps of producing a plurality of codebooks for the decompression of encoded difference data, wherein at least one of said codebooks contains codevectors, which have been weighted to a specific frequency distribution; and, decompressing data using the codebooks in combination, to produce a decompression result which comprises at least a plurality of significant frequencies contained in said data prior to compression.

Yet another aspect of the invention teaches an encoder for compressing data, comprising means for encoding the data, means for forming difference data between the data and the encoded data, means for dividing the difference data into one or more primary blocks, forming the latest difference data blocks. This aspect of the invention further comprises means for iteratively repeating the following step of re-encoding and calculating independently for each block, until a desired accuracy level of compressed data is achieved, means for re-encoding a step-specific difference data block, which is the latest difference data block, using a codebook, elected suitable for each repetition, the codebook for said step-specific difference block containing codevectors, and means for calculating a following difference block between the step-specific difference block and the encoded step-specific difference block, forming the latest difference data block. At least one of said codebooks contains codevectors trained with training difference material, wherein prior the training, said training difference material is preprocessed for individually adapting frequency distribution of each codevector for weighting to particular information of the data.

The encoder preferably implements all or some of the method described above.

The invention further contemplates in another aspect, a decoder for decompression of encoded data, the encoded data containing a plurality of encoded difference data said decoder comprising a compressed data input module; a decompression module adapted to utilize at least one codebook that has been weighted to a specific frequency distribution, and a decompressed data output module. Similarly to the encoder, the decoder preferably utilizes all or some of the different features described in the decoding method above or other reciprocating feature of the encoding method described.

While the method above describes iterative repetition, it should be clear that such iterations are not limited to loops and include methods such as recursion and other well known techniques either by a single or multiple processing units for performing the step described repeatedly on the data or various portions thereof.

### BRIEF DESCRIPTION OF THE DRAWINGS

In the following the invention is described in more detail by means of FIGS. 1-11 in the attached drawings where.

FIG. 1 illustrates an example of a frame of size N1*M1 pixels,

FIG. 2 illustrates an example of a division of a frame into blocks of size N*N pixels,

FIG. 3 illustrates an example of a block of size N*N pixels, a vector representing the block, and a code vector for quantizing the vector,

FIG. 4 illustrates an example of a known vector quantization arrangement,

FIG. 5 illustrates an example of the training of difference material according to the invention,

FIGS. 6 and 7 illustrate a simple example of the inventive way to code each block with a block specific number of coding stages,

FIG. 8 illustrates an example of an arrangement containing evaluation means according to the invention,

FIG. 9 illustrates an example of a flow chart describing the inventive method, and

FIG. 10 illustrates an example of an arrangement for the invention,

FIG. 11 illustrates an example of a decoder adapted to use at least one inventive codebook.

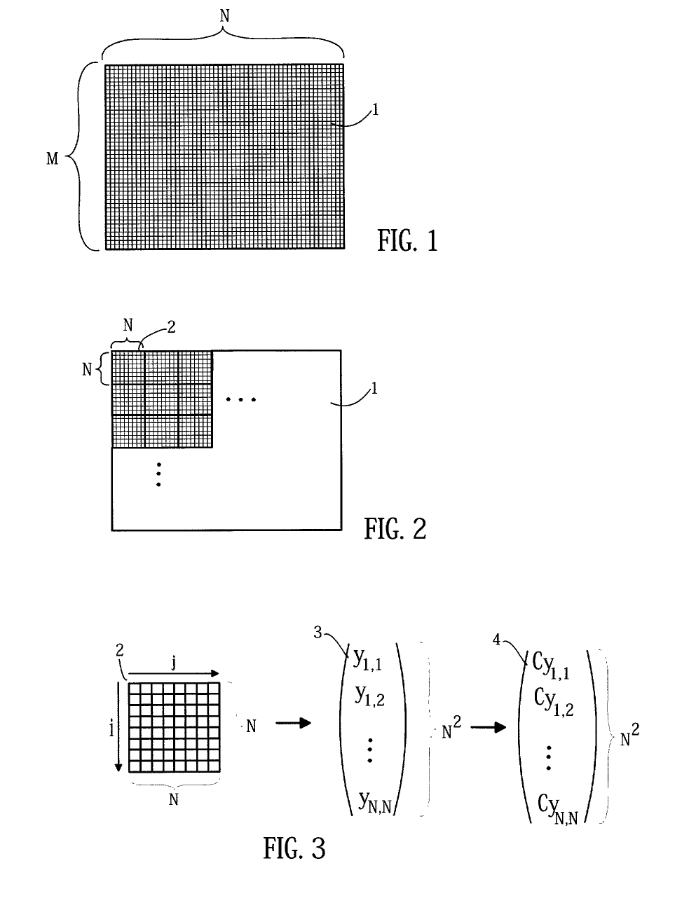

### DETAILED DESCRIPTION OF THE INVENTION

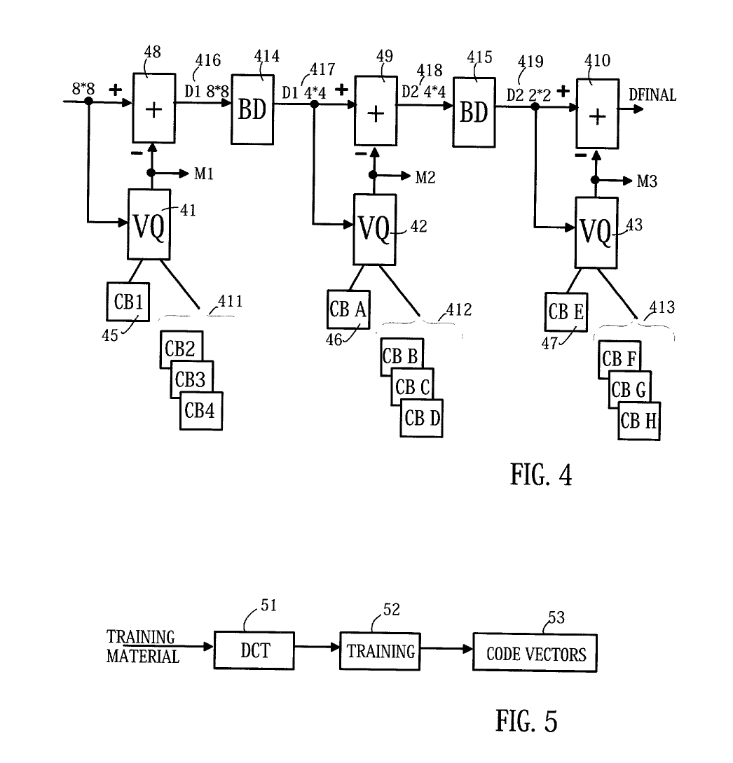

FIG. 4 illustrates an example of a known vector quantization arrangement. The invention significantly improves the performance of the arrangement, expanding the fields to which the arrangement is applicable. It should be noted that if in this text a block is mentioned in the singular, it is done in order to increase the readability and understanding of the invention, while in practice all blocks of images are coded/decoded.

Let us consider an original 8×8 block. At the first stage, this block is coded 41 using either one codebook 45 or alternatively several codebooks 411. As described earlier, classified codebooks can be used in a cascaded VQ. Since the coding concerns the original block, the first stage belongs to the basic mode. The difference 416 between the original block and the coded block is calculated 48. The difference, i.e. the encoding error, can, for example, be measured in standard terms as the distortion

$${d}_{tot}^{2} = {\sum }_{i = 1}^{N} {\sum }_{j = 1}^{N} {d}_{i , j}^{2} = {\sum }_{i = 1}^{N} {\sum }_{j = 1}^{N} {( {Y}_{i , j}^{o} - {Y}_{i , j}^{e} )}^{2} ,$$

where dₜₒₜ denotes the total distortion for an N×N block and d_{i,j} the distortion of the pixel in the ith row and jth column of the block; Y_{i,j}^{o} and Y_{i,j}^{e} are the luminance values of that pixel in the original and encoded blocks, respectively.

The distortion block is divided 414 into four 4×4 subblocks 417, which are encoded 42 at a second stage (the difference mode) using codebook A 46 or alternatively several codebooks 412. Each difference coded 4*4 block is subtracted 49 from the original 4*4 difference block. The remaining differences 418 are then further divided 415 into four 2×2 subblocks. Each 2*2 difference block 419 is encoded 43 using another codebook E 47 or alternatively codebooks 413. Each coded 2*2 difference block is subtracted 410 from the original 2*2 difference block for achieving final remaining difference. It should be noted that the block sizes might alternatively remain at each stage, in which case the divisions of the blocks are not performed.

Each codebook is trained with realistic ‘image’ material, i.e., at the difference mode with actual difference blocks occurring at the stage where the codebook is to be used. The training consists of finding a given number of vectors, which represent the training set as best as possible. This is achieved using the standard k-means algorithm. The measure of goodness is the sum of the Euclidian distances between the training vectors and the code vectors closest to them.

This far the described procedure is equivalent to the usual cascaded VQ and possesses the same virtues such as the simple decoding. The invention consists of two modifications, thereof, that are designed to solve the main weaknesses and strengthen the performance.

Firstly, as shown in FIG. 5, the training material used in the training of the codebooks is to be pre-processed 51 for predetermining the frequency distribution of the resulting codevectors. This is done by cosine transforming all the training blocks, removing some component of the transform, e.g. certain frequency components, by setting their coefficients to zero, and finally attaining the new training block via inverse transformation. It should be noted that DCT is not the only way to preprocess training material, but another suitable functional transform can be used.

The motivation behind this procedure is twofold. For one thing, it is visually more important to focus the limited number of bits on correcting the low-frequency errors than trying to correct the whole block containing all frequencies. The coefficients, representing frequencies, can be ranked in terms of their importance for the human observer: the eye is more sensitive to the lower spatial frequencies than to the higher ones. This does not necessarily indicate low frequencies in some absolute terms smaller block sizes necessarily generate higher frequencies, and a thus more limited spread of the DCT function. In other words, the resulting code vector (or vectors) is adapted to a desired frequency distribution.

Secondly, all the code vectors in two or more codebooks trained with distinct frequency regimes are at least nearly orthogonal and can be efficiently used together to complement each other. This notion increases the number of possible code vectors achieved with the combination of the basic encoding and two or more stages of difference encoding. The restriction of the code vectors to a limited number of DCT frequencies effectively reduces the vector dimension. For this reason, a codebook of a given size matches the training vectors better than if no frequency selection has been done. This fact leads to still more effective encoding of the visually important components in the difference blocks.

Some possible frequency selections with practical applications include: blocks with just the lower frequencies, blocks with zero mean value, and blocks with intermediate frequencies (higher than the lowest frequency blocks, but not the highest ones). After the preprocessing, the actual training is performed 52, from which the best matching code vectors 53 are found, and codebooks are formed.

The other modification to the standard cascaded VQ concerns the spatial adaptability of the difference encoding. In the spirit of DWT, the usage of further difference modes is decided separately for each block, i.e., the encoding of one block may involve several successive stages of difference encoding while its neighbouring block is decided to be encoded well enough with the mere basic mode.

The encoded data sent to the decoder comprises the indices of M1, M2, M3, etc, shown in FIG. 4.

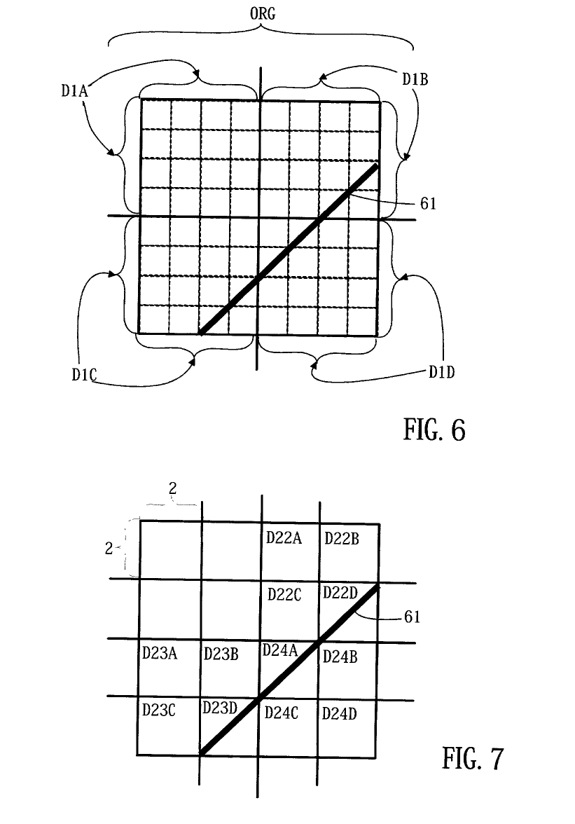

FIGS. 6 and 7 illustrate a simple example of the inventive way to code each block with a block specific number of coding stages, FIG. 6 shows an 8*8 block ORG which is coded (compare FIG. 4, 41) and the difference between the original and the coded block is divided (FIG. 4, 417) into 4*4 blocks D1A to D1D at the first encoding stage. After this, each block is examined for the need of a further stage of coding. Since the original 8*8 block illustrates a line 61 across a uniform background, the coding of the first stage is sufficient for block D1A wherein only the uniform background information exist. The examination reveals that the other blocks, D1B to D1D may benefit from further coding in a second compression stage.

FIG. 7 shows a division of the coded 4*4 difference blocks (FIG. 4, 415) into 2*2 blocks D22A-D22D, D23A-D23D, and D24A-D24D at the second compression stage. After the division, each block is examined for the need of a further stage of coding. Since blocks D22A, D22B, D22C, D23A, D23B, D23C, D24B, D24C, and D24C illustrate only a minor part of the line 61 across the uniform background or purely the background, the coding of the second stage is sufficient for these blocks. The other blocks D22D, D24A, and D23D need further a third stage of coding. As a result of coding the original 8*8 block, one 4*4 block, i.e. block D1A, has been coded using one stage, several 2*2 blocks (blocks D22A, D22B, D22C, D23A, D23B, D23C, D24B, D24C, and D24C) have been coded using two stages, and three 2*2 blocks (D22D, D24A, and D23D) have been coded using three stages.

The decision for using additional stages of coding is based on rate-distortion considerations in the form of a cost function involving the relative cost for using further bits while achieving some reduction in the block's distortion. In other words, if the cost of using additional stage is too high, the use of additional stage(s) is unnecessary. The cost function may be weighted in a desired way, i.e. weighting the cost of the bits used in proportion to distortion. Preferably, the weighting takes into account the weighted use of bits per a distortion value (such as a distortion value of luminance or chrominance components). The use of bits may be weighted linearly or nonlinearly over the range of distortion values. The selection of the most appropriate cost function may be preselected, or determined by conditions at the time of transmission, by user selection, or any other convenient method.

The advantage of this procedure is the increased flexibility of the bit allocation across each frame. Consequently, the difficult regions can be encoded with a succession of difference modes and code vectors while simpler regions can be corrected once or left as they are. This flexibility increases the usage of the difference stages for any given bit rate.

Due to the abovementioned matters the inventive arrangement may benefit from evaluation means for examining the need of using additional coding stages. As FIG. 8 shows, the evaluation means 102 can preferably be implemented into the division modules (compare FIG. 4, 414, 415, and 410) used 101, but the evaluation means can be an individual module.

### Preferable Implementation of the Invention

The inventive arrangement takes a difference block as input at each difference mode stage and encodes it further in order to reduce the remaining error in an efficient manner as compared with the additional bits required. The difference block may be the result from any prior encoding such as basic VQ encoding, motion compensation, DCT, or DWT.

The inventive solution consists of two parts: the training of the codebooks and a method for utilizing them in video encoding. Let us, for example, consider a frame from a gray-scale video, which has been encoded with some combination of VQ and motion compensation using 8×8 block size. The resulting difference image is divided into 4×4 blocks, which are to be encoded in two further stages.

Several training algorithms are known in the art. By way of example, the reader is referred to Lloyd's algorithm presented in Y. Linde, A. Buzo, and R. M. Gray, “An algorithm for vector quantizer design”, IEEE Transactions on Communications, 28(1), pp. 84-95, January 1980. An alternative algorithm known as k-means or C-means. This was first presented in J. B. McQueen, “Some Methods of classification and analysis of multivariate observations”, Proceedings of 5th Berkeley Symp. Mathemat. Statist. Probability 1, pp. 281-296, University of California, Berkeley, 1967.

The training of the first difference codebook, codebook A, has been performed with realistic difference material, but with the lowest frequency, i.e., the constant component removed. The standard k-means algorithm tends to emphasize the lower frequencies, but cannot generate fictitious finite averages to the resulting vectors. For a codebook with 256 vectors, the frequencies are concentrated to the lower half of the frequency table.

The second stage codebook, codebook B, is trained with difference blocks where, e.g., one third of the lowest frequencies have been removed. The resulting code vectors do have some weight in these frequencies due to the training algorithm but the emphasis is on the higher frequencies. Therefore the code vectors from codebooks A and B can efficiently complement each other. The fact that there is some overlap between the codebooks can be utilized by combining two vectors from A or two vectors from B or one from each. The overlap can be avoided by performing the training with the transform coefficients before the inverse transformation.

The actual encoding proceeds by first searching for the best matching vector from codebook A for each 4×4 block. Then the blockwise reductions in the distortion are calculated and the induced rate-distortion cost is compared with the cost without using the difference vectors. A typical cost function is C=d+λb, where d is the distortion, λ is a weighting factor, and b the number of bits used for the block. It should be noted that the weighting factor can also be attached to d, or the weighting can be handled using separate weighing factors attached to d and b. Code vectors are chosen only for those blocks for which this reduces the cost. In the next step, best matching code vectors in codebook B are searched for the remaining 4×4 difference blocks. Again code vectors are chosen only when it is cost efficient. The positions for the code vectors can be expressed by single bits so that one byte is enough to determine which subblocks of the original 8×8 block are corrected with vectors from codebook A and which from codebook B.

Finally, the code vectors are centered around zero and have predominantly very small values. Such codebooks can be efficiently compressed before being transmitted to the receiving end, thereby reducing the initial waiting time for the video recipient.

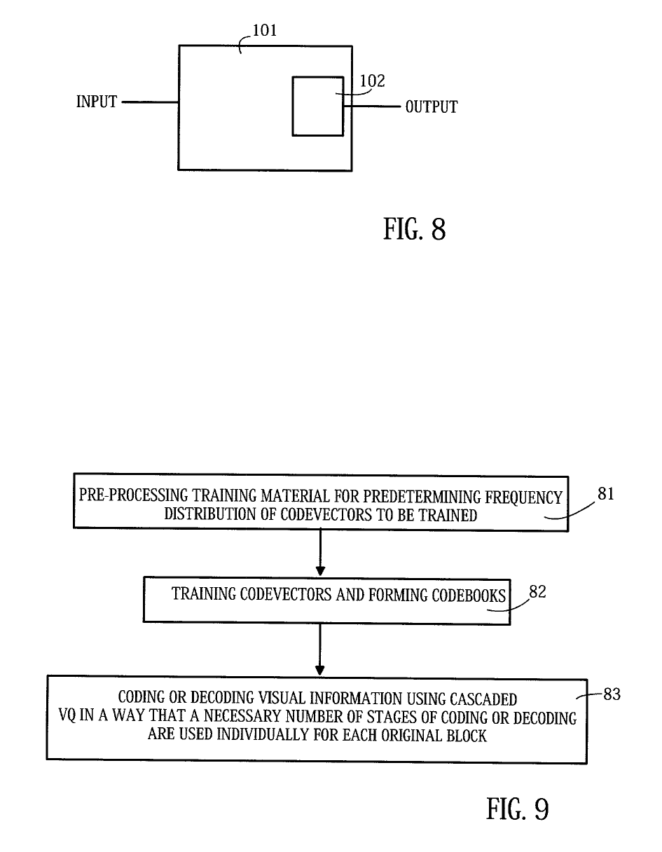

FIG. 9 illustrates an example of a flow chart describing the inventive method. First step 81 is to pre-process training material for predetermining frequency distribution of codevectors to be trained. Preferably the pre-processing is made beforehand, it is an important step for achieving the desired performance of any arrangement according to the invention. The next step 82 is to train codevectors using the pre-processed training material. Codebooks are formed. Finally, information is coded/decoded 83 using a cascaded VQ in a way that a necessary number of stages of coding or decoding is used individually for each original block.

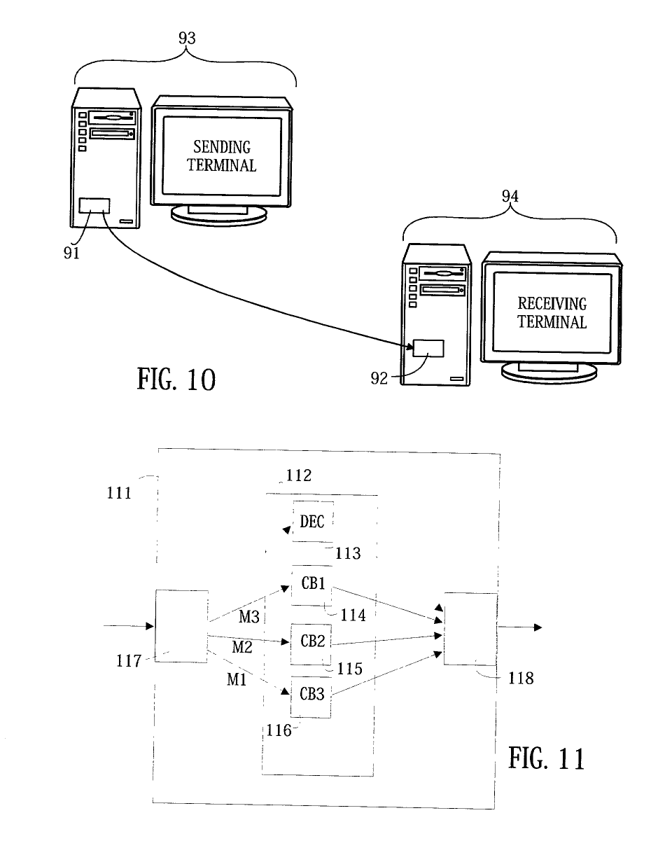

FIG. 10 illustrates an example of an arrangement for the invention. In practical usage, the invention is embedded as a part of complete video compression/decompression software. The compression, i.e. coding, software 91 is normally situated in a sending terminal 93. The software typically consists of a user interface; media readers for reading in the video and audio information; some form of basic encoding; the difference encoding methods and codebooks proposed in this invention; communication link for sending the stream; and a small decoding software package 92 to be transmitted in the beginning of the video stream to a receiving terminal 94. However, alternatively, the decoding software may be permanently situated in the receiving terminal

FIG. 11 represent an example of a decoder 111 adapted to use at least one inventive codebook. The decoder comprises an input module 117 for compressed data, which contains data that has been compressed using some encoding method, such as DCT or a codebook of a VQ method, and compressed difference data. The compressed difference data has been formed using codebooks of VQ, the difference data is in the form of indices (M1, M2, M3) of the codebooks. The input module directs the compressed data to a decompression module 112, containing a decoding module 113 and several codebooks 114, 115, 116, in a way that the encoded data is directed to the decoding module and the difference data to the codebooks according to the indices. After the decompression in the decompression module the decompressed data is combined in a output module 118, from where the combined data is sent for later use. At least one of the codebooks 114, 115, 116, has been weighted according to the invention, but preferably all codebooks have been weighted. It should be noted that alternatively it is also possible to combine the decompressed data in a separate module before the output module 118, and the direction of the compressed input data in another separate module after the input module.

The invention combines the best properties of several of the existing solutions. It should be noted that the encoding of original information can be made using any encoding technique, such as VQ, motion compensation, or some functional transform, and difference information is handled using VQ. The invention may benefit from a number of fast-search algorithms, such as the tree-search VQ, to increase the speed of codebook searches.

Although the inventive encoding is mostly described in this context, it is clear that the invention also concerns decoding. When decoding, the codebooks used must contain codevectors, which are weighted for certain frequency distribution. Using these codebooks together, a decompression result obtains at least the most significant frequencies. There also exist many alternative forms and adaptations for the invention. For example, any form of ‘basic’ encoding of intra and inter frames (i.e. blockwise or non-blockwise), functional transform or vector quantization, can be an underlying technique for the inventive arrangement, since they all leave a residual or difference between the original images and the encoded/decoded ones. The invention may also be used as one step in a sequence of difference encoding with optional variation of block size in each step. In other words, in each sequence (stage) the difference block may be processed, for example using DCT, before coding the difference block. That is to say a pre-encoding before an actual coding. The difference can be encoded blockwise with any block size. A vector library for the difference vectors may be trained in any basis, i.e., as image blocks or functional transforms thereof. Codebook(s) may also be adaptively modified during the encoding process. The encoding procedure and ideas presented herein are applicable to any color presentation such as RGB, YUV, YCrCb, CieLAB, etc.

It will be clear to those skilled in the art that an encoder or decoder in accordance with the present invention may be implemented as software being executed on a general purpose, a special purpose computerized system. Alternatively, the encoder or decoder may be implemented as a dedicated hardware solution, or as a combination of hardware and software. Thus the invention aims to cover both implementations

To conclude in light of the above demands, there is a need for a video compression technology, which achieves high compression ratios while retaining good perceptual image quality and whose decoding side requires only minimal processing power. It is also evident that the invention provides a solution for that need, and can be implemented in many solutions within the scope of the invention, as will be clear to a person skilled in the art.

What is claimed is:

1. An encoding method for compressing data, the method comprising the steps of:
(a) encoding the data to produce encoded data;
(b) forming difference data between the data and the encoded data;
(c) dividing the difference data into one or more primary blocks, forming difference blocks;
(d) using a selected codebook re-encoding a difference block to produce an encoded difference block;
(e) calculating a following difference block between said difference block and the encoded difference block, forming secondary difference blocks;
(f) iteratively repeating steps d, e and f, until a desired level of compression is achieved;
(g) wherein said step f is preformed for a plurality of selected primary and secondary difference blocks;
(h) wherein the codebook for said step d is selected for each iteration from a plurality of codebooks, at least one of said codebooks contains codevectors trained with training difference material, wherein prior to the training, said training difference material is preprocessed for individually adapting frequency distribution of at least one of said codevectors for weighting to particular portions of the data.

2. A method according to claim 1, wherein at least at one of said repetitions the difference blocks are divided into sub-blocks at least one of which to be used as difference blocks at a subsequent repetition.

3. A method according to claim 1, wherein a plurality of codebooks are used in said step d.

4. A method according to claim 2, wherein a plurality of codebooks are used in said step d.

5. A method according to claim 1, wherein the preprocessing of the training material is made using discrete cosine transform.

6. A method according to claim 1, wherein the preprocessing of the training material is made using a functional transform.

7. A method according to claim 1, further comprising the steps of evaluating the cost of a repetition using a cost function which produces a cost result, and deciding if to perform the next repetition based on the basis of said result.

8. A method according to claim 7, wherein the cost function utilizes a remaining difference, and a number of bits used for representing said difference block, to calculate a cost of further repetitions.

9. A method according to claim 8, wherein the number of bits is weighted.

10. A method according to claim 2, wherein the preprocessing of the training material is made using discrete cosine transform.

11. A method according to claim 2, wherein the preprocessing of the training material is made using a functional transform.

12. A method according to claim 2, further comprising the steps of evaluating the cost of a repetition using a cost function which produces a cost result, and deciding if to perform the next repetition based on the basis of said result.

13. A method according to claim 12, wherein the cost function utilizes a remaining difference, and a number of bits used for representing said difference block, to calculate a cost of further repetitions.

14. A method according to claim 13, wherein the number of bits is weighted.

15. A method according to claim 3, wherein the preprocessing of the training material is made using discrete cosine transform.

16. A method according to claim 3, wherein the preprocessing of the training material is made using any functional transform.

17. A method according to claim 3, further comprising the steps of evaluating the cost of a repetition using a cost function which produces a cost result, and deciding if to perform the next repetition based on the basis of said result.

18. A method according to claim 17, wherein the cost function utilizes a remaining difference, and a number of bits used for representing said difference block, to calculate a cost of further repetitions.

19. A method according to claim 18, wherein the number of bits is weighted.

20. A method according to claim 4, wherein the preprocessing of the training material is made using discrete cosine transform.

21. A method according to claim 4, wherein the preprocessing of the training material is made using a functional transform.

22. A method according to claim 4, further comprising the steps of evaluating the cost of a repetition using a cost function which produces a cost result, and deciding if to perform the next repetition based on the basis of said result.

23. A method according to claim 22, wherein the cost function utilizes a remaining difference, and a number of bits used for representing said difference block, to calculate a cost of further repetitions.

24. A method according to claim 23, wherein the number of bits is weighted.

25. A method according to claim 1, wherein at least at one repetition the difference blocks are preprocessed before encoding.

26. A method according to claim 2, wherein at least at one repetition the difference blocks are preprocessed before encoding.

27. A decoding method for pre-compressed data, the method comprising the steps of:
producing a plurality of codebooks for the decompression of encoded difference data, wherein at least one of said codebooks contains codevectors, which have been weighted to a specific frequency distribution; and,
decompressing data using the codebooks in combination, to produce a decompression result which comprises at least a plurality of significant frequencies contained in said data prior to compression.

28. An encoder for compressing data, comprising:
a) means for encoding the data;
b) means for forming difference data between the data and the encoded data;
c) means for dividing the difference data into one or more primary blocks, forming the latest difference data blocks;
d) means for iteratively repeating the following step of re-encoding and calculating independently for each block, until a desired accuracy level of compressed data is achieved:
e) means for re-encoding a step-specific difference data block, which is the latest difference data block, using a codebook, elected suitable for each repetition, the codebook for said step-specific difference block containing codevectors;
f) means for calculating a following difference block between the step-specific difference block and the encoded step-specific difference block, forming the latest difference data block;
g) and at least one of said codebooks contains codevectors trained with training difference material, wherein prior the training, said training difference material is preprocessed for individually adapting frequency distribution of each codevector for weighting to particular information of the data.

29. An encoder according to claim 28, wherein at least at one repetitions the difference blocks are divided into sub-blocks for being used as difference blocks at a subsequent repetitions.

30. An encoder according to claim 28, wherein said means for re-encoding are adapted to use a plurality of codebooks.

31. An encoder according to claim 29, wherein said means for re-encoding are adapted to use a plurality of codebooks.

32. An encoder according to claim 28, wherein the evaluation means further comprise a cost function, which calculates the cost of using the additional repetition.

33. An encoder according to claim 32, wherein the cost function takes into account a remaining difference, and the number of bits used for representing said difference block, to calculate a cost of further repetitions.

34. An encoder according to claim 33, wherein the number of bits is weighted.

35. An encoder according to claim 29, wherein the evaluation means further comprises a cost function, which calculates the cost of using the additional repetition.

36. An encoder according to claim 35, wherein the cost function the cost function utilizes a remaining difference, and a number of bits used for representing said difference block, to calculate a cost of further repetitions.

37. An encoder according to claim 36, wherein the number of bits is weighted.

38. An encoder according to claim 30, wherein the evaluation means further comprises a cost function, which calculates the cost of using the additional repetition.

39. An encoder according to claim 38, wherein the cost function the cost function utilizes a remaining difference, and a number of bits used for representing said difference block, to calculate a cost of further repetitions.

40. An encoder according to claim 39, wherein the number of bits is weighted.

41. An encoder according to claim 31, wherein the evaluation means further comprises a cost function, which calculates the cost of using the additional repetition.

42. An encoder according to claim 41, wherein the cost function the cost function utilizes a remaining difference, and a number of bits used for representing said difference block, to calculate a cost of further repetitions.

43. An encoder according to claim 42, wherein the number of bits is weighted.

44 A compressed data decoder for decompression of encoded data, the encoded data containing a plurality of encoded difference data said decoder comprising:
a compressed data input module;
a decompression module adapted to utilize at least one codebook that has been weighted to a specific frequency distribution; and,
a decompressed data output module.

45. A computer readable media containing software that when executed by a computer, will case said computer to perform substantially in accordance with the method of claim 1.

46. A computer readable media containing software that when executed by a computer, will case said computer to perform substantially in accordance with the method of claim 27.

47. A computer readable media containing software that when executed by a computer, will case said computer to perform substantially as the encoder of claim 28.

48. A computer readable media containing software that when executed by a computer, will case said computer to perform substantially as the decoder of claim 44.
